(19) United States
(12) Patent Application Publication
(10) Pub. No.: US 2018/0333916 A1
(43) Pub. Date: Nov. 22, 2018

(54) THREE-DIMENSIONAL PRODUCT MANUFACTURING APPARATUS

(71) Applicants: Hyundai Motor Company, Seoul (KR); Kia Motors Company, Seoul (KR); EELCEE Ltd., Suwon-si (KR)

(72) Inventors: Jeong Min Cho, Suwon-si (KR); Hyun Jun Kim, Anyang-si (KR); Jee Young Youn, Incheon (KR); Chi Hoon Choi, Suwon-si (KR); Hyun Gyung Kim, Hwaseong-si (KR); Queein Chang Mansson, Seoul (KR); Jan-Anders Mansson, West Lafayette, IN (US)

(73) Assignees: Hyundai Motor Company, Seoul (KR); Kia Motors Company, Seoul (KR); EELCEE Ltd., Suwon-si (KR)

(21) Appl. No.: 15/824,071

(22) Filed: Nov. 28, 2017

(30) Foreign Application Priority Data
May 16, 2017 (KR) 10-2017-0060555

(51) Int. Cl. B29C 64/245; B29C 64/232; B29C 64/321; B29C 64/379; B29C 64/118

(52) U.S. Cl. CPC B29C 64/245; B29C 64/232; B33Y 30/00; B29C 64/379; B29C 64/118; B29C 64/321

(57) ABSTRACT

A three-dimensional product manufacturing apparatus, may include a shape guide portion including a seating portion; a discharge portion discharging a material onto the seating portion while moving along the seating portion; and a material fixing portion fixing the material discharged from the discharge portion to the fixing portion, in which the seating portion moves the material fixed by the fixing portion depending on a predetermined process sequence and the material is sequentially processed.

### CROSS-REFERENCE(S) TO RELATED APPLICATIONS

The present application claims priority to Korean Patent Application No. 10-2017-0060555, filed on May 16, 2017, the entire contents of which is incorporated herein for all purposes by this reference.

### BACKGROUND OF THE INVENTION

### Field of the Invention

The present invention relates to a three-dimensional product manufacturing apparatus, and more particularly, to a three-dimensional product manufacturing apparatus based on a material including a formable plastic material.

### Description of Related Art

Recently, techniques for manufacturing an internal reinforcement member for reinforcing a strength and durability of the member using a plastic composite material have been employed. Research regarding internal framework manufacturing techniques including additive manufacturing equipment and internal reinforcements of polymers and composites have been actively conducted.

3D printing and 3D molding are attracting attention because use of the internal reinforcement can increase the mechanical performance while reducing usage of raw materials of lightweight composite materials. The internal reinforcement can improve an additive manufacturing speed to serve as a portion of an automation process.

Additive manufacturing technology has a very high potential value in that it may be extended to various fields including aircraft, electronic components, consumer electronics, sporting goods, building materials as well as automobile parts markets. However, more research and development has to be made to manufacture sophisticated framework structures in a cost-effective manner.

The additive manufacturing apparatus for manufacturing the internal framework uses raw materials of elongated strands. Since most of the raw materials are easily solidified, cured, or degraded materials, technologies for preventing raw materials from being solidified, cured, or degraded until being discharged to the outside through the internal to the additive manufacturing apparatus are required.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a three-dimensional (3D) product manufacturing apparatus configured for discharging raw materials at a correct position and being suitable for mass production.

According to an exemplary embodiment of the present invention, there is provided a three-dimensional product manufacturing apparatus, including: a shape guide portion including a seating portion; a discharge portion configured for discharging a material onto the seating portion while moving along the seating portion; and a material fixing portion configured for fixing the discharged material to the seating portion, in which the seating portion may move from a first position to a second position after the material fixing portion fixes the material, and subsequent processes on the fixed material may be performed when the seating portion is positioned at the second position.

The shape guide portion may include a jig, and the jig may have the seating portion disposed along an external circumference thereof.

The seating portion may be provided with a groove on which the material is seated.

The material fixing portion may include a cylinder activated when the discharge portion discharges the material to a predetermined position, and a fixed cover moving according to the cylinder when the cylinder is activated to fix the discharged material to the seating portion.

The shape guide portion may have a shape of a polygonal pillar and the seating portion may be disposed on one side surface of the polygonal pillar.

The one side surface may be the first position, the other side surface of the polygonal pillar may be the second position, the process configuration corresponding to the subsequent process may be disposed on the other side surface, and the shape guide portion may rotate with respect to a central axis of the polygonal pillar to move the seating portion from the first position to the second position.

The discharge portion may be a three-dimensional manufacturing robot arm.

The discharge portion may be a stacked 3D printer.

The subsequent process may be any one of a cooling process of cooling the material, a cutting process of cutting the material, and a loading process of separating the solidified material from the seating portion and loading the material into a separate area.

The material may include at least one of a strand, a yarn, a tow, a bundle, a band, and a tape.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating a three-dimensional product manufacturing apparatus according to an exemplary embodiment of the present invention;

FIG. 2 is a perspective view illustrating an exemplary embodiment of the three-dimensional product manufacturing apparatus of FIG. 1;

FIG. 3 is a front view of the three-dimensional product manufacturing apparatus of FIG. 2;

FIG. 4 is a diagram illustrating an exemplary embodiment in which a material is discharged onto a seating portion included in the three-dimensional product manufacturing apparatus of FIG. 2;

FIG. 5 is a diagram illustrating an exemplary embodiment in which a material fixing portion included in the three-dimensional product manufacturing apparatus of FIG. 2 fixes the discharged material to the seating portion;

FIG. 6 is a diagram illustrating an exemplary embodiment in which the seating portion included in the three-dimensional product manufacturing apparatus of FIG. 1 moves from a first position to a second position; and

FIG. 7 is a diagram illustrating another exemplary embodiment in which the seating portion included in the three-dimensional product manufacturing apparatus of FIG. 1 moves from the first position to the second position.

It should be understood that the appended drawings are not necessarily to scale, presenting a somewhat simplified representation of various features illustrative of the basic principles of the invention. The specific design features of the present invention as disclosed herein, including, for example, specific dimensions, orientation, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

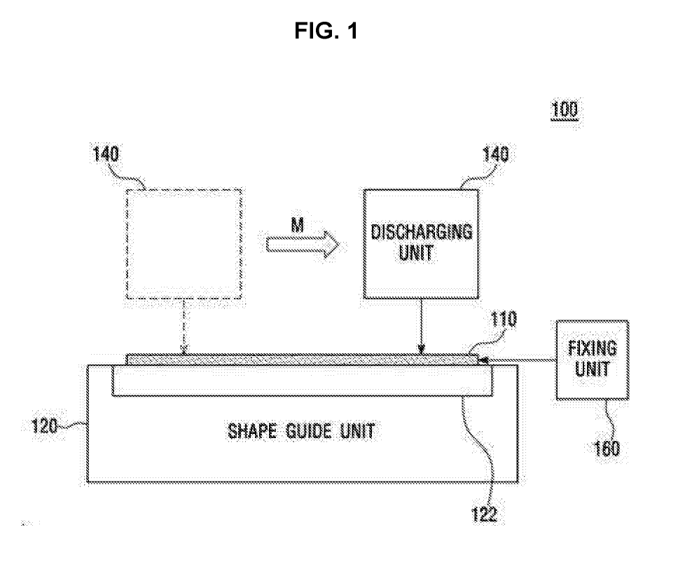

FIG. 1 is a block diagram showing a three-dimensional product manufacturing apparatus according to an exemplary embodiment of the present invention.

Referring to FIG. 1, a three-dimensional product manufacturing apparatus 100 may include a shape guide portion 120, a discharge portion 140, and a material fixing portion 160.

A material 110 may include a material that configures a three-dimensional product to be manufactured later. According to the exemplary embodiment, the material 110 may be stacked, and the additive material 110 may be cured to manufacture a three-dimensional product.

Accordingly, the material 110 may be selected as a material and/or a form suitable to manufacture a predetermined three-dimensional product. For example, the material 110 may include at least one of a strand, a yarn, a tow, a bundle, a band, and a tape.

The shape guide portion 120 may include a seating portion 122. Here, the seating portion 122 may have a groove on which the material 110 is seated. According to the exemplary embodiment, the shape guide portion 120 may include a jig that has the seating portion 122 disposed along an external circumference thereof.

The seating portion 122 may have various shapes. Since the shape of the three-dimensional product to be manufactured later may be influenced by the shape of the seating portion 122 to be manufactured later, the seating portion 122 and the shape guide portion 120 including the same may have a shape corresponding to the shape of the three-dimensional product to be manufactured.

When the seating portion 122 is disposed along the external circumference of the jig, the shape formed by the external circumference of the jig may be substantially the same as the shape of the three-dimensional product to be manufactured later. For example, when the jig has a circular shape, the manufactured three-dimensional product may have an annular shape formed along a circumference of the circle. The jig may have a three-dimensional shape. In the present case, the shape of the seating portion 122 disposed in the jig may also be three-dimensional.

The discharge portion 140 can move M along the seating portion 122. The discharge portion 140 can discharge the material 110 onto the seating portion 122 while moving M along the seating portion 122. For example, the discharge portion 140 can discharge the material 110 to a predetermined target point positioned on the seating portion 122 while freely moving three dimensionally. For example, in an exemplary embodiment of the present invention, the discharge portion 140 may be a three-dimensional product manufacturing robot arm. For example, the three-dimensional product manufacturing robot arm may move M along the seating portion 122 having a three-dimensional shape. At the present time, the seating portion 122 can also rotate and/or move in accordance with a motion of the three-dimensional product manufacturing robot arm.

In another exemplary embodiment of the present invention, the discharge portion 140 may be a stacked 3D printer. For example, the discharge portion 140 may be the stacked 3D printer that manufactures a three-dimensional product by stacking the material 110 at a predetermined position.

According to the present embodiment, the discharge portion 140 may be fixed at a predetermined position. That is, the discharge portion 140 may not move M. For example, the discharge portion 140 has a shape corresponding to the shape of the seating portion 122 and may be fixedly disposed at a predetermined position. In the present case, the discharge portion 140 can discharge the material 110 onto the seating portion 122 without the movement M. Alternatively, the discharge portion 140 may be fixed and the jig moves, wherein the material 110 may be disposed on the seating portion 122.

The material fixing portion 160 may fix the material 110 discharged from the discharge portion 140 to the seating portion 122. In other words, the material fixing portion 160 applies a pressure to the discharged material 110 wherein the discharged material 110 is not separated from the seating portion 122.

According to various aspects of the present invention, the material fixing portion 160 may include a cylinder and a fixed cover. Here, the cylinder may be activated when the discharge portion 140 discharges the material 110 to a predetermined position, and the fixed cover may move according to the cylinder when the cylinder is activated to fix the discharged material 110 to the seating portion 122.

In an exemplary embodiment of the present invention, a plurality of first to third cylinders may each be connected to a first to a third fixed covers. Here, the first to third cylinders may each be activated sequentially at first timing when the discharge portion 140 discharges the material 110 to a first position, second timing when the discharge portion 140 discharges the material 110 to a second position, and third timing when the discharge portion 140 discharges the material 110 to a third position. As a result, the first to third fixed covers, which are connected to the first to third cylinders, respectively, may sequentially move at the first to the third timings to fix the discharged material 110 to the seating portion 122.

In another exemplary embodiment of the present invention, the plurality of first to third cylinders may be connected to a fixed cover. Here, the first to third cylinders may be activated at the same time when the discharge portion 140 discharges the material 110 to a single position. As a result, the fixed cover may move by a common output of the first to third cylinders, and fix the discharged material 110 to the seating portion 122.

The material 110 fixed by the material fixing portion 160 is solidified while being fixed on the seating portion, wherein a three-dimensional product having a predetermined shape may be manufactured.

According to the present embodiment, the material 110 fixed by the material fixing portion 160 may be fixed and then subjected to subsequent processes. Here, the subsequent process may include one or more processes to finally form the fixed material 110 as a three-dimensional product. For example, the subsequent process may be one of a cooling process, a cutting process, or a loading process. The cooling process may be a process of cooling and/or heating the fixed material 100 to a predetermined temperature, the cutting process may be a process of cutting the fixed material 110, and the loading process may be a process of separating the solidified material 110 from the seating portion (122) and loading the material 110 into a separate area.

In the present case, the seating portion 122 included in the shape guide portion 120 may move together with the fixed material 110 for the subsequent processes. For example, the shape guide portion 120 may rotate by a predetermined angle with respect to a rotation axis after the material fixing portion 160 fixes the material 110. As a result, the seating portion 122 may move from the first position to the second position. At the present time, a cutter waiting for the subsequent processes may cut a portion of the fixed material 110 after the shape guide portion 120 rotates by a predetermined angle. That is, the subsequent processes for the fixed material 110 may be performed when the seating portion 122 is positioned at the second position.

Here, such a series of processes may be continuously implemented. For the present purpose, the shape guide portion 120 may have a shape of a polygonal pillar on which a plurality of seating portions are disposed, the configuration of the corresponding process may be disposed on each side of the shape guide portion 120, and the shape guide portion 120 may rotate about a central axis of the polygonal pillar, wherein the discharging and fixing processes and the subsequent processes on each side may be continuously realized.

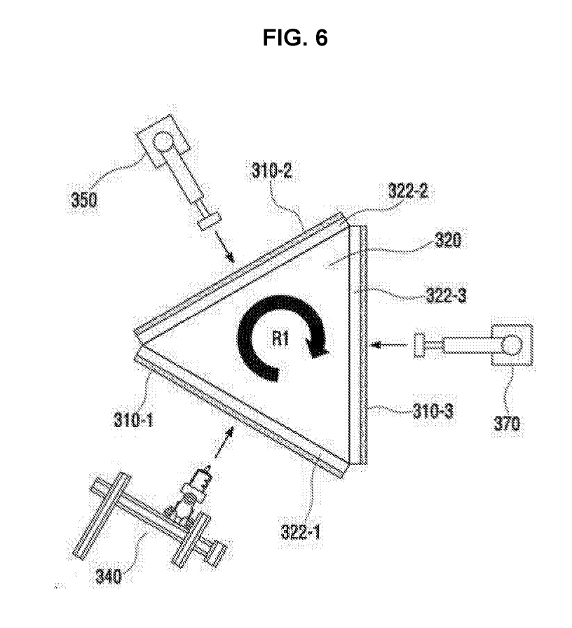

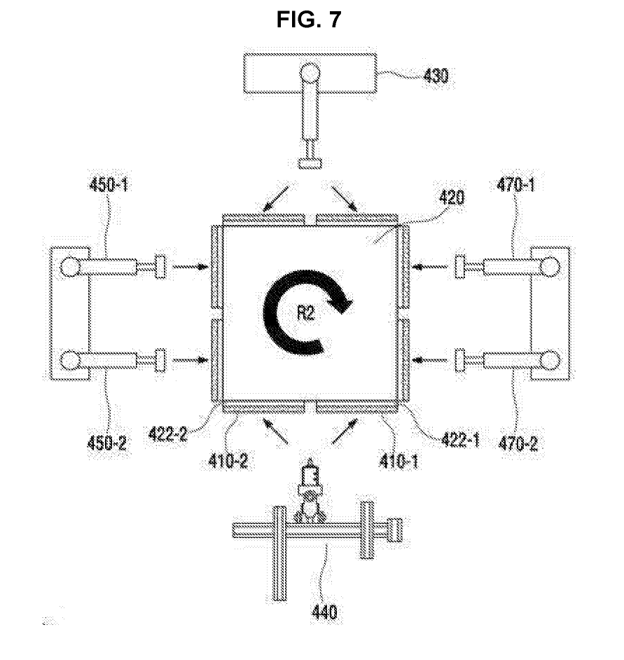

The configuration and operation of the shape guide portion 120 and the seating portion 122 included therein will be described in detail with reference to FIG. 6 and FIG. 7.

According to the three-dimensional product manufacturing apparatus 100 having the above configuration, the discharge portion 140 discharges the material 110 onto the seating portion 122 and then the material fixing portion 160 fixes the discharged material 110 to the seating portion 122, wherein the material 110 is fixed at a correct position. Furthermore, since the seating portion 122 may be performed while moving from the first position to the second position, the present process may be suitable for mass production.

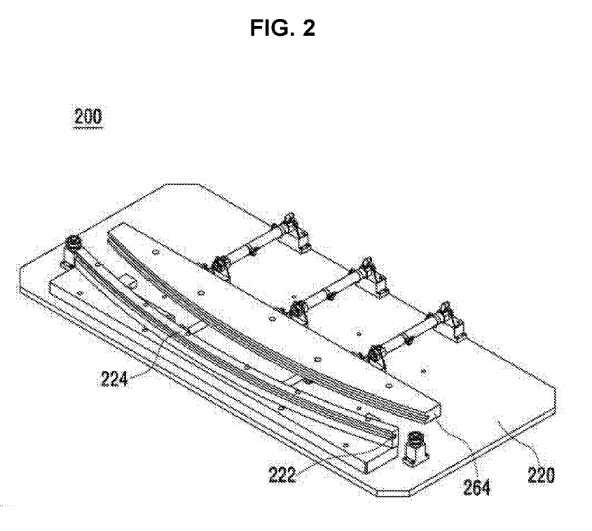

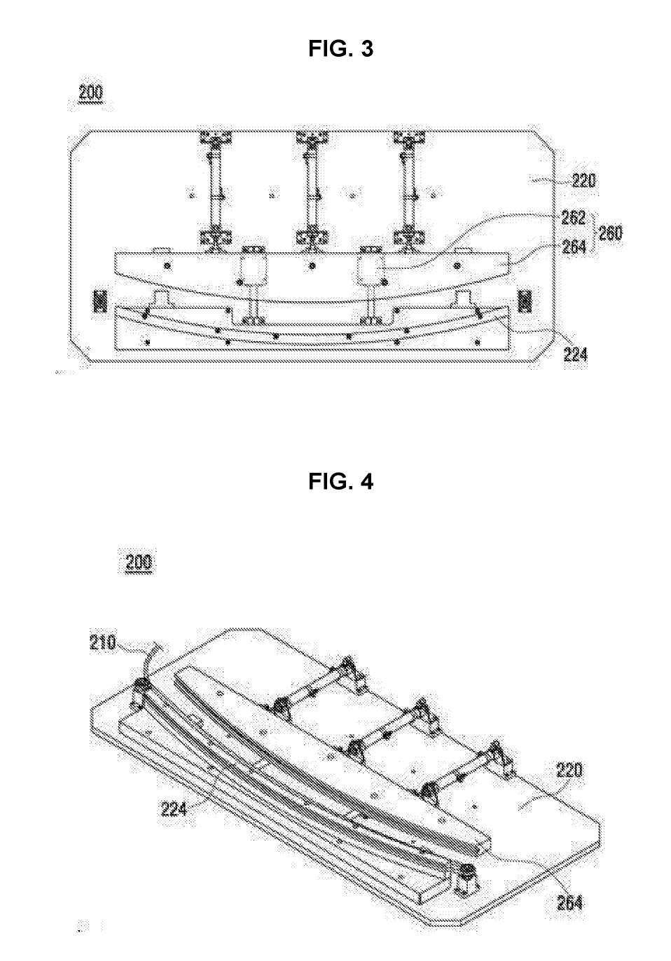

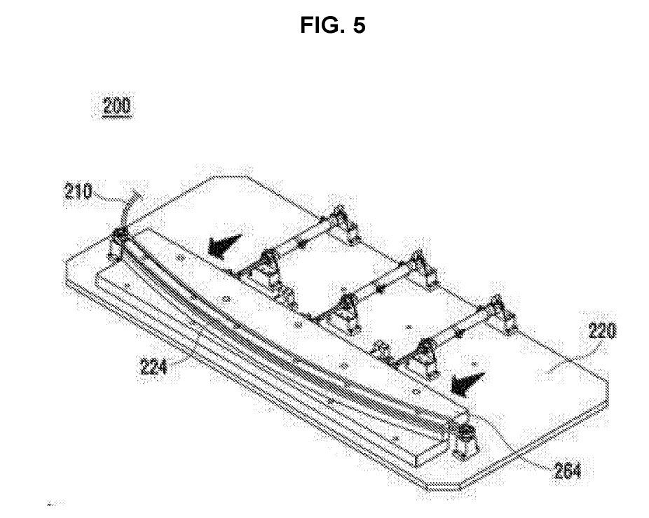

FIG. 2 is a perspective view illustrating an exemplary embodiment of the three-dimensional product manufacturing apparatus of FIG. 1, FIG. 3 is a front view of the three-dimensional product manufacturing apparatus of FIG. 2, FIG. 4 is a diagram illustrating an exemplary embodiment in which a material is discharged onto a seating portion included in the three-dimensional product manufacturing apparatus of FIG. 2, and FIG. 5 is a diagram illustrating an exemplary embodiment in which a material fixing portion included in the three-dimensional product manufacturing apparatus of FIG. 2 fixes the discharged material to the seating portion.

Referring to FIG. 2, FIG. 3, FIG. 4, and FIG. 5, a three-dimensional product manufacturing apparatus 200 may include a shape guide portion 220, a discharge portion 140, and a material fixing portion 260.

A material 210 may include a material that configures a three-dimensional product to be manufactured later. According to the present embodiment, the material 210 may be stacked, and the stacked material 210 may be cured to manufacture a three-dimensional product.

Accordingly, the material 210 may be selected as a material and/or a form suitable to manufacture a predetermined three-dimensional product. For example, the material 210 may include at least one of a strand, a yarn, a tow, a bundle, a band, and a tape.

The shape guide portion 220 may include a seating portion 222. Here, the seating portion 222 may have a groove on which the material 210 is seated. The shape guide portion 220 may include a jig that has the seating portion 222 disposed along an external circumference thereof.

The seating portion 222 may have various shapes. Since the shape of the three-dimensional product to be manufactured later may be affected by the shape of the seating portion 222, the seating portion 222 and the shape guide portion 220 including the same may have a shape corresponding to the shape of the three-dimensional product to be manufactured.

Like the present embodiment, when the seating portion 222 is disposed along the external circumference of the jig 224, the shape formed by the external circumference of the jig 224 may be substantially the same as the shape of the three-dimensional product to be manufactured later.

The discharge portion may move along the seating portion 222. The discharge portion may discharge the material 210 onto the seating portion 222 while moving along the seating portion 222. For example, the discharge portion can discharge the material 210 to a predetermined target point positioned on the seating portion 222 while freely moving three dimensionally.

In an exemplary embodiment of the present invention, the discharge portion may be a three-dimensional product manufacturing robot arm.

In another exemplary embodiment of the present invention, the discharge portion 240 may be a stacked 3D printer. For example, the discharge portion 240 may be the stacked 3D printer that manufactures a three-dimensional product by stacking the material 210 at a predetermined position.

The material fixing portion 260 may fix the material 210 discharged from the discharge portion to the seating portion 222. In other words, the material fixing portion 260 applies a pressure to the discharged material 210 wherein the discharged material 210 is not separated from the seating portion 222.

According to the present embodiment, the material fixing portion 260 may include a cylinder 262 and a fixed cover 264. Here, the cylinder 262 may be activated when the discharge portion discharges the material 210 to a predetermined position, and the fixed cover 264 may move according to the cylinder 262 when the cylinder 262 is activated to fix the discharged material 210 to the seating portion 222.

The cylinder 262 may be connected to the fixed cover 264. Here, the cylinder 262 may be activated at a time when the discharge portion discharges the material 210 to a position. As a result, the fixed cover 264 may move by the output of the cylinder 262 and may fix the discharged material 210 to the seating portion 222.

The material 210 fixed by the material fixing portion 260 is solidified while being fixed on the seating portion 222, wherein a three-dimensional product having a predetermined shape may be manufactured.

FIG. 6 is a diagram illustrating an exemplary embodiment in which the seating portion included in the three-dimensional product manufacturing apparatus of FIG. 1 moves from a first position to a second position.

Referring to FIG. 6, a shape guide portion 320 may include a first seating portion 322-1, a second seating portion 322-2, and a third seating portion 322-3. Furthermore, a first material 310-1, a second material 310-2, and a third material 310-3 may each be disposed on the respective seating portions 322 by the discharge portion 340. At the present time, the shape guide portion 320 may have a shape of a triangular pillar, and each of the seating portions 322 may be disposed on a respective side of the triangular pillar.

The material 310 fixed by the material fixing portion 160 may be fixed and then subjected to subsequent processes. Here, the subsequent process may include one or more processes to finally form the fixed material 310 as a three-dimensional product. For example, the subsequent process may be one of a cooling process, a cutting process, or a loading process. The cooling process may be a process of cooling and/or heating the fixed material 310 to a predetermined temperature, the cutting process may be a process of cutting the fixed material 310, and the loading process may be a process of separating the finally solidified material 310 from the seating portion 322 and loading the material 310 into a separate area.

In the present case, the first seating portion 322-1 included in the shape guide portion 320 may move together with the fixed first material 310-1 for the subsequent processes. For example, the shape guide portion 320 may rotate R1 by a predetermined angle with respect to a rotation axis after the material fixing portion fixes the first material 310-1. As a result, the first seating portion 322-1 may move from the first position to the second position (i.e., the first position of the second seating portion 322-2). At the present time, the cutter 350 waiting for the subsequent processes may cut a portion of the fixed first material 310-1 after the shape guide portion 320 rotates by a predetermined angle. That is, the subsequent processes for the fixed first material 310-1 may be performed when the first seating portion 322-1 is positioned at the second position. This does not mean that the cutting is performed only when the fixed first material 310-1 is rotated once to the second position. Even if the shape guide portion 320 does not rotate at a predetermined angle, it is possible to cut the material in the jig first. In this case, the cutter 350 is used for trimming the material or for additional cutting.

Furthermore, the shape guide portion 320 may rotate R1 by a predetermined angle with respect to a rotation axis after the cutter 350 cuts the first material 310-1. As a result, the first seating portion 322-1 may move from a second position to a third position (i.e., the first position of the third seating portion 322-3). At the present time, the loading device 370 waiting for the subsequent processes may rotate the cut first material 310-1 from the first seating portion 322-1 after the shape guide portion 320 is further rotated by a predetermined angle and then load the first material 310-1 into a separate area. In addition, the loading apparatus 370 can perform a process of preparing the discharge portion 340 to easily discharge a fourth material to the first seating portion 322-1.

Here, such a series of processes may be continuously implemented. For the present purpose, the shape guide portion 120 may have a shape of a triangular pillar on which a plurality of seating portions are disposed, the configuration of the corresponding process may be disposed on each side of the shape guide portion 120, and the shape guide portion 120 may rotate about a central axis of the polygonal pillar, wherein the discharging and fixing processes and the subsequent processes on each side may be continuously realized.

FIG. 7 is a diagram illustrating another exemplary embodiment in which the seating portion included in the three-dimensional product manufacturing apparatus of FIG. 1 moves from a first position to a second position.

Referring to FIG. 7, a shape guide portion 420 may include a plurality of seating portions 422. The material 410 may be disposed on each seating portion 422. At the present time, the shape guide portion 420 may have a shape of a rectangular pillar, and each of the seating portions 422 may be disposed on a side of the rectangular pillar.

According to the present embodiment, the plurality of seating portions 422 may be disposed on the side of the polygonal pillar. For example, a first seating portion 422-1 on which the first material 410-1 is disposed and a second seating portion 422-2 on which the second material 410-2 is disposed may be disposed on the side of a polygonal pillar together.

According to the present embodiment, a single process configuration of any processes may process all the subsequent processes for the plurality of materials 410 each disposed on the plurality of seating portions 422. For example, a single first process configuration 430 may process all the subsequent processes on both the first material 410-1 and the second material 410-2 that rotated R2 twice.

According to the present embodiment, the plurality of process configurations of any processes may each take charge of the subsequent processes for the plurality of materials 410 each disposed on the plurality of seating portions 422 and process them. For example, a plurality of second process configurations 450-1 and 450-2 may each take care of the subsequent processes for the first material 410-1 and the second material 410-2 that rotated R2 once, and the plurality of third process configurations 470-1 and 470-2 may each take care of the subsequent processes for the first material 410-1 and the second material 410-2 that rotated R2 three times and may process them.

According to the exemplary embodiment of the present invention, it is possible to fix materials at a correct position by allowing the discharge portion to discharge the materials onto the seating portion and then the material fixing portion to fix the discharged materials to the seating portion.

In addition, it is possible to implement mass production by allowing the seating portion to continuously perform the subsequent processes while moving the materials.

For convenience in explanation and accurate definition in the appended claims, the terms “upper”, “lower”, “up”, “down”, “upwards”, “downwards”, “internal”, “outer”, “inside”, “outside”, “inwardly”, “outwardly”, “internal”, “external”, “front”, “rear”, “back”, “forwards”, and “backwards” are used to describe features of the exemplary embodiments with reference to the locations of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A three-dimensional product manufacturing apparatus, comprising:
a shape guide portion including a seating portion;
a discharge portion configured for discharging a material onto the seating portion while moving along the seating portion; and
a material fixing portion configured for fixing the material discharged from the discharge portion to the fixing portion,
wherein the seating portion moves the material fixed by the material fixing portion depending on a predetermined process sequence and the material is sequentially processed while the seating portion moves a position of the material.

2. The three-dimensional product manufacturing apparatus of claim 1, wherein the shape guide portion includes a jig and the jig has the seating portion disposed along an external circumference thereof.

3. The three-dimensional product manufacturing apparatus of claim 1, wherein an external surface of the seating portion is provided with a groove in which the material is seated.

4. The three-dimensional product manufacturing apparatus of claim 1, wherein the material fixing portion includes:
a cylinder extended in a direction of the material discharged to the seating portion; and
a fixed cover coupled to an end portion of the cylinder to press the material to be fixed to the seating portion.

5. The three-dimensional product manufacturing apparatus of claim 1, wherein the shape guide portion is provided in a shape of a polygonal pillar, and
the seating portion is disposed on a side of the shape guide portion.

6. The three-dimensional product manufacturing apparatus of claim 5, wherein the shape guide portion is provided in a polygonal pillar shape having side surfaces corresponding to a number corresponding to a processing frequency of the material and one side surface thereof is a first position and other side surfaces thereof adjacent to each other along a direction rotating with respect to a central shaft of the polygonal pillar is a second position,
the second position is provided with a process configuration corresponding to a subsequent process of the first position, and
the shape guide portion rotates with respect to a central axis of the polygonal pillar to move the seating portion from the first position to the second position.

7. The three-dimensional product manufacturing apparatus of claim 1, wherein the discharge portion is a three-dimensional manufacturing robot arm.

8. The three-dimensional product manufacturing apparatus of claim 1, wherein the discharge portion is a stacked 3D printer.

9. The three-dimensional product manufacturing apparatus of claim 1, wherein the subsequent process is one of a cooling process of cooling the material, a cutting process of cutting the material, and a loading process of separating the solidified material from the seating portion and loading the material into a separate area.

10. The three-dimensional product manufacturing apparatus of claim 6, wherein the material includes at least one of a strand, a yarn, a tow, a bundle, a band, and a tape.
